(19) United States
(12) Patent Application Publication
(10) Pub. No.: US 2015/0060401 A1
(43) Pub. Date: Mar. 5, 2015

(54) METHOD OF EDGE COATING A BATCH OF GLASS ARTICLES

(71) Applicant: Corning Incorporated, Corning, NY (US)

(72) Inventors: Shih-Min Chang, Taipei City (TW); Cheng-Ta Chen, Tainan City (TW); UeiJie Lin, Taichung City (TW); Hsien Li Lu, Taichung City (TW)

(21) Appl. No.: 14/467,523

(22) Filed: Aug. 25, 2014

Related U.S. Application Data
(60) Provisional application No. 61/871,367, filed on Aug. 29, 2013.

(51) Int. Cl. C03C 15/02; C03C 19/00; C03C 17/00; C03C 17/30; C03C 17/32; C03C 17/28

(52) U.S. Cl. CPC C03C 15/02; C03C 17/32; C03C 17/28; C03C 17/002; C03C 17/30; C03C 19/00; C03C 2218/111; C03C 2218/112; C03C 2218/116; C03C 2218/119; C03C 2218/34; C03C 2217/74
USPC 216/38

(57) ABSTRACT

A method of edge coating a batch of glass articles includes printing masks on surfaces of a glass sheet, where at least one of the masks is a patterned mask defining a network of separation paths. The glass sheet with the printed masks is divided into multiple glass articles along the separation paths. For at least a batch of the glass articles, the edges of the glass articles in the batch are finished to reduce roughness at the edges. Each finished edge is then etched with an etching medium to reduce and/or blunt flaws in the finished edge. A curable coating is simultaneously applied to the etched edges. The curable coatings are pre-cured. Then, the printed masks are removed from the glass articles with the curable coatings. After removing the printed masks, the pre-cured curable coatings are post-cured.

This application claims the benefit of priority under 35 U.S.C. §119 of U.S. Provisional Application Ser. No. 61/871367, filed on Aug. 29, 2013, the content of which is relied upon and incorporated herein by reference in its entirety.

### FIELD

The field relates to methods for strengthening glass substrates that have been subjected to weakening processes such as separation and machining. More particularly, the field relates to a process for strengthening the edge of a glass substrate by reducing flaws in the glass edge and applying a protective coating to the glass edge.

### BACKGROUND

One method for producing glass articles involves forming a glass sheet, subjecting the glass sheet to an ion-exchange process, separating the glass sheet into multiple glass articles, and machining the edges of each glass article. Machining is used to reduce the roughness of the glass edges and to shape the glass edges to a desired profile, such as a chamfered profile or rounded profile. The separation and machining processes typically leave the glass edges with flaws, e.g., cracks and chips, of various shapes, sizes, and dimensions. These flaws reduce the strength of the glass edges and can lead to generation of cracks in the finished glass articles. Also, the portions of the glass edges that were previously in the interior of the glass sheet will be largely free of the protective residual compressive stress from the ion-exchange process, making the finished glass articles weaker than the parent glass sheet.

One method for strengthening an edge of a glass article involves etching the edge with an acid. The etching may have the effect of reducing the number and sizes of flaws in the glass edge. Another method for strengthening an edge of a glass article involves applying a protective coating or material to the edge.

### SUMMARY

The subject matter disclosed herein relates to a method of protecting edges of glass articles. As described in the background, separation and machining processes induce flaws in glass edges. These flaws can be reduced and/or blunted by acid etching of the glass edges. However, the flaws will still be in the glass edges. A coating can be used to cover the flaws on the edges. After the edge coating process, direct impact with flaws in the edges will be prevented, which will have the effect of further improving the edge strength of the glass articles beyond that achieved by etching of the glass edges. The subject matter disclosed herein particularly relates to a method of coating glass edges that is suitable for use in mass production of glass articles.

In one illustrative embodiment of the disclosure, a method of edge coating a batch of glass articles includes printing masks on surfaces of a glass sheet. At least one of the masks is a patterned mask defining a network of separation paths. The glass sheet with the printed masks are separated into multiple glass articles along the separation paths, where each glass article carries a portion of the printed masks on its surfaces. For at least a batch of the glass articles, the edge of each glass article in the batch is then finished to reduce roughness of the edge and possibly shape the edge. The method includes etching the finished edge of each glass article to reduce the sizes of and/or blunt flaws in the finished edge. A curable coating is simultaneously applied to the etched edges, followed by pre-curing the curable coatings on the edges. After pre-curing, the surface masks are removed from the glass articles. Then, the pre-cured curable coatings are post-cured.

One benefit of the method of coating glass edges as described in this disclosure includes improved edge strength of the coated glass articles. In some embodiments, the improvements in edge strength can be 80 MPa to 300 MPa compared to glass articles without edge coatings. Other benefits are due to the use of surface masks on the glass articles. For example, the surface masks allow finishing and etching process speeds to be increased, which ultimately results in increased throughput. The surface masks also prevent overflow of coating material directly onto the glass surfaces. The surface masks also make it possible to coat glass edges without following the glass edges with a dispenser along a straight line. This makes it possible to coat edges of glass articles with various shapes and sizes.

It is to be understood that both the foregoing general description and the following detailed description are exemplary of the disclosure and are intended to provide an overview or framework for understanding the nature and character of the subject matter of the disclosure as it is claimed. The accompanying drawings are included to provide a further understanding of the disclosure and are incorporated in and constitute a part of this specification. The drawings illustrate various embodiments of the disclosure and together with the description serve to explain the principles and operation of the disclosure.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a process flow for coating a batch of glass edges.

FIG. 2 shows patterned masks printed on surfaces of a glass sheet.

FIG. 3 shows a method of printing a mask on a surface of a glass sheet.

FIG. 4A is a top view of a glass sheet with a patterned mask and score lines.

FIG. 4B shows a glass article separated from the glass sheet of FIG. 4A.

FIG. 5 shows a dip-and-spin coating process.

FIG. 6A is a side view of a cassette for holding multiple glass articles.

FIG. 6B is an enlargement of section 6B of FIG. 6A.

FIG. 6C is a top view of a plate included in the cassette of FIG. 6A.

FIG. 7 shows another dip-and-spin coating system.

FIG. 8A shows a top view of a plate included in a cassette of the dip-and-spin coating system of FIG. 7.

FIG. 8B shows a bottom view of the plate of FIG. 8A.

FIG. 9 shows a spray coating system.

FIG. 10 is a SEM image of edge coating by a dip-and-spin coating process.

FIG. 11 is a SEM image of edge coating by a spray coating process.

FIG. 12 shows improvement in edge strength by edge coating.

### DETAILED DESCRIPTION

In the following detailed description, numerous specific details may be set forth in order to provide a thorough understanding of embodiments of the disclosure. However, it will be clear to one skilled in the art when embodiments of the disclosure may be practiced without some or all of these specific details. In other instances, well-known features or processes may not be described in detail so as not to unnecessarily obscure the disclosure. In addition, like or identical reference numerals may be used to identify common or similar elements.

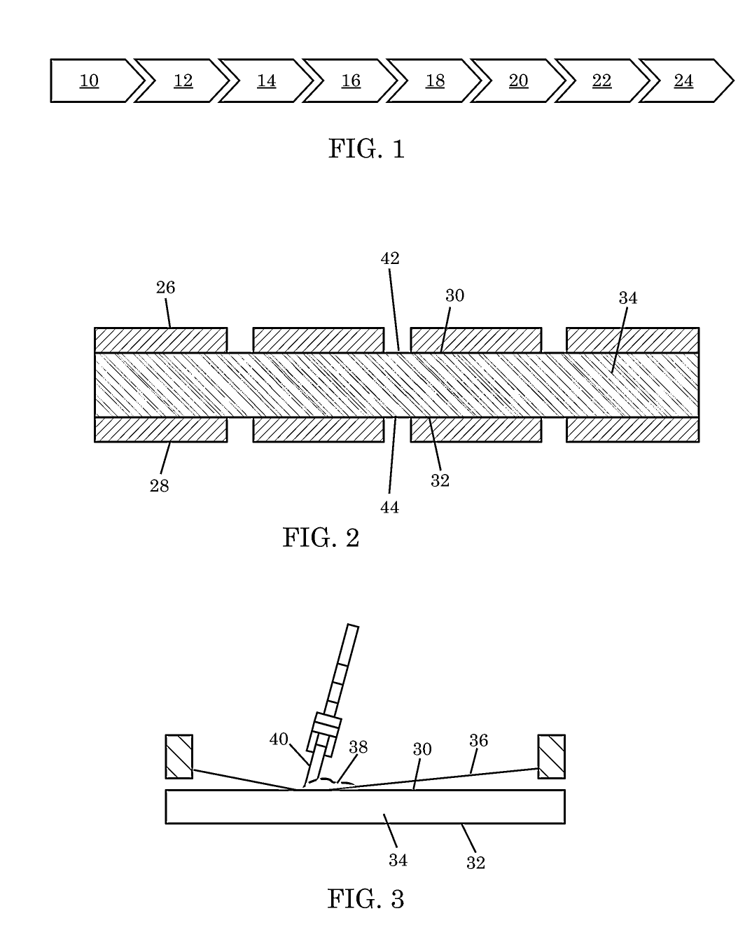

FIG. 1 shows an illustrative process flow for coating the edges of a batch of glass articles with a protective material. A batch of glass articles will be understood to mean a set of glass articles. Generally, a batch of glass articles will comprise more than two glass articles. Typically, a batch of glass articles will have 5 to 20 glass articles. The process starts at 10 with printing of masks on the surfaces of a glass sheet (“surface masking”). After surface masking 10, the glass sheet with the surface masks is separated into multiple glass articles (“sheet separation”) at 12. After sheet separation 12, the edges of the glass articles are finished (“edge finishing”) at 14. The finishing involves machining processes designed to remove rough material from the glass edges and shape the glass edges into a desired edge profile, typically an edge profile selected to improve the edge strength of the glass articles. After edge finishing 14, acid etching is used to reduce sizes of flaws and to blunt tips of flaws in the glass edges (“edge etching”) at 16. After etch etching 16, a curable coating is simultaneously applied to the edges of a batch of glass articles (“edge coating”) at 18. The term “edge” of a glass article will be understood to refer to the peripheral edge of the glass article. After edge coating 18, the curable coating is pre-cured (“pre-curing”) at 20. After pre-curing 20, the masks are removed from the surfaces of the glass articles (“surface unmasking”) at 22. After surface unmasking 22, the pre-cured coating on the edges of the glass articles is post-cured (“post-curing”) at 24.

Surface Masking—FIG. 2 shows masks 26, 28 printed on the surfaces 30, 32 of a glass sheet 34. In one embodiment, the glass sheet 34 is a glass sheet that has been strengthened by ion-exchange. In one embodiment, the ion-exchange depth is at least 29 μm. The masks 26, 28 are provided to protect the glass surfaces during edge finishing (14 in FIG. 1) and edge etching (16 in FIG. 1). For this reason, the masks 26, 28 must be resistant to the acid(s) used during edge etching (16 in FIG. 1) and to peeling off during edge finishing (14 in FIG. 1). Preferably, the masks 26, 28 will also not react with the curable coating applied to the glass edges during edge coating (18 in FIG. 1). In addition to protecting the glass surfaces, the masks 26, 28 are also patterned to define paths for separating the glass sheet 34, such as shown at 42, 44, respectively. Typically, the thickness of each mask 26, 28 will be in a range from 30 μm to 50 μm. Thicknesses below 30 μm and above 50 μm are also possible for the masks 26, 28. Also, it is not necessary that the thicknesses of the masks 26, 28 are the same.

In one illustrative embodiment, the surface masks 26, 28 are printed on the glass surfaces 30, 32 by screen printing. Screen printing can be used to print a design on a large surface with good accuracy and at a relatively low cost. As illustrated in FIG. 3, the glass sheet 34 is mounted below a screen 36, which carries a mask pattern to be printed on the surfaces of the glass sheet 34. The mask pattern is created on the screen 36 by masking off pores in a select area of the screen 36 while leaving the pores in the remaining area of the screen 36 open. Ink (or solution type mask material) 38 is deposited on the screen 36 and pushed through the open pores of the screen 36 onto the glass surface 30. A machine or operator draws a squeegee 40 across the screen 36 to push the ink 38 through the screen 36. The squeegee 40 will flex the screen 36 into close proximity with the glass surface 30, and the ink 38 will be squeezed by capillary action onto the glass surface, where the spacing between the flexed screen 36 and the glass surface 30 will determine the thickness of the ink on the glass surface 30. The ink deposited on the glass surface 30 is cured to complete the screen printing of the mask 26 (in FIG. 2) on the glass surface 30. The screen printing process is repeated for the glass surface 32, resulting in the mask 28 (in FIG. 2) on the glass surface 32.

The properties of the ink 38 used for printing of the masks 26, 28 of FIG. 2 will determine the character of the masks. The ink will need to be acid-resistant as mentioned above. It may not be necessary that the ink is resistant to all acids. However, the ink should be resistant to the acid(s) that will be used in edge etching (16 in FIG. 1). The ink can be a thermally-curable ink or a UV-curable ink. Thermally-curable inks are cured by baking at high temperatures, generally between 80° C. and 180° C. The baking time is typically between 30 minutes and 60 minutes. UV-curable inks are cured by UV light. UV curing is generally much faster than thermal curing. In one illustrative embodiment, the ink is a thermally-curable ink composed of oligomer, monomer, hardener, and additive. In another illustrative embodiment, the ink is a UV-curable ink composed of oligomer, monomer, photoinitiator, and additive. The photoinitiator is needed for triggering or stimulating polymerization during UV curing. The UV-curable ink may be of the type that is cured by free radical polymerization or of the type that is cured by cationic polymerization. Thermally- and UV-curable inks are available commercially or can be specially formulated based on desired properties of the masks 26, 28 (in FIG. 2).

In one illustrative embodiment, a UV-curable ink formulation F comprises 10% to 60% by weight of an oligomer, 10% to 40% by weight of a monomer, and 1% to 15% by weight of a photoinitiator. The UV-curable ink formation may further include one or more additives in a total amount of up to 30% by volume of the ink. The UV-curable ink formulation F may be of the free radical type or of the cationic type. In one embodiment where the UV-curable ink formulation F is of the cationic type, the oligomer is selected from epoxy resin oligomers. In another embodiment where the UV-curable ink formulation F is of the free radical type, the oligomer is selected from unsaturated polyester resin and acrylic resin oligomers.

Examples of acrylic resin oligomers are epoxy acrylate, urethane acrylate, and polyester acrylate oligomers. Table 1 compares the properties of these acrylic resins. Epoxy acrylate has a short curing time and good chemical resistance. Examples of epoxy acrylate are bisphenol A epoxy, alkyl type epoxy acrylate, and PE type epoxy acrylate. Urethane acrylate is flexible and hard compared to epoxy acrylate. Urethane acrylate may be based on isocyanates such as isophorone diisocyanate (IPDI), toluene diisocyanate (TDI), hexamethylene diisocyanate (HDI), methylene dicyclohexyl diisocyanate (H12MDI), and methylene diphenyl diisocyanate (MDI). Polyester acrylate has lower molecular weight and lower viscosity compared to urethane acrylate and epoxy acrylate. Epoxy acrylate has a viscosity of approximately 5 to 6 times that of polyester acrylate in the same molecular weight. Table 1 compares the properties of these acrylic resins.

TABLE 1

| | Epoxy | Urethane | Polyester |
|---|---|---|---|
| | Acrylate | Acrylate | Acrylate |
| Viscosity | High | High | Variable |
| Monomer Dilution | Easy | Easy | Easy |
| Viscosity reduction | Good | Fair | Good |
| Hardening rate | Fast | Variable | Variable |
| Relative coat | Low | High | Low |
| Tension | High | Variable | Variable |
| Softness | Poor | Good | Variable |
| Anti-chemical | Excellent | Good | Good |
| resistance | | | |
| Hardness | High | Variable | Moderate |
| Non-yellowing | Moderate | Variable | Poor |
| | to poor | | |

The monomer in the UV-curable ink formulation F is used to dilute the oligomer in the UV-curable ink formulation F. The monomer allows the UV-curable ink formulation F to be prepared without use of organic solvents. Examples of monomers are vinyl monomer, propylene monomer, and acrylic monomer. The monomers can be single or multifunctional according to the amount of functional groups. Multifunctional monomers are typically used in the ink. Examples of multifunctional acrylic monomers are trimethylolpropane triacrylate (TMPTA), dipentaerythritol hexaacrylate (DPHA), and dipentaerythritol pentaacrylate (DPEPA). In an illustrative embodiment, the UV-curable ink formulation F comprises polyvinyl chloride (PVC) as a monomer.

The photoinitiator in the UV-curable ink formulation F should decompose after absorbing UV light and have thermal stability at room temperature. The photoinitiator may be a radical photoinitiator or a cationic photoinitiator. The radical photoinitiator, after absorbing UV light, will decompose into free radicals, which will cause rapid polymerization of the oligomer and monomer. Radical polymerization stops when UV irradiation stops. The cationic photoinitiator, after absorption of UV light, will leave cations that stimulate polymerization. The cationic polymerization continues even after exposure to UV light is terminated and generally until polymerization is complete. Cationic photoinitiators can be used with epoxy resin oligomer. Examples of cationic photoinitiators are ferrocenium salt, triarysulfonium salt, and diaryliodonium salt. Radical photoinitiators can be used with acrylic resin oligomer. Examples of radical photoinitiators are trichloroacetophenones, benzophene, and benzil dimethyl ketal.

Additives used in the UV-curable ink formulation F can be selected from fillers, silane coupling agent, light blocking agent, and the like. Filler is used to enhance the viscosity of the ink. Examples of fillers are silicate, silica, titanium oxide, and clay. Silane coupling agents are organofunctional silanes that are used to provide a stable bond between an inorganic material, such as glass, and an organic material, such as polymer. The general structure is (RO)₃Si—X, where X are reactive groups that form chemical bonds with organic materials, e.g., vinyl groups, epoxy groups, amino groups, methacryloxy groups, mercapto groups, and others, and RO are reactive groups that form chemical bonds with inorganic materials, e.g., methoxy groups, ethoxy groups, and others.

In one illustrative embodiment, a thermally-curable ink formulation G comprises 10% to 60% by weight of an oligomer and 10% to 40% by weight of a monomer. The thermally-curable ink formulation G may further include one or more additives in a total amount of up to 30% by volume of the ink. The thermally-curable ink formulation G may further include a hardener in a total amount of approximately 10% to 20% by weight. Common hardeners such as epoxy, diethylenetriamine (DETA), and trimethyl hexamethylene diamine (TMD) may be used. The oligomer, monomer, and additives may be as described above for the UV-curable ink formulation F.

The character of the ink and screen printing process recipe will impact the quality of the printed masks. The printing speed generally varies with the viscosity of the ink. If the viscosity is too high, printing will be slow. If the viscosity is low, printing will be fast, but the ink may then drip through the screen. Thus the viscosity should be selected to optimize printing speed while avoiding dripping of ink through the screen. In some embodiments, the viscosity of the ink is in a range from 7,000 cps to 30,000 cps, and the printing speed is in a range from 100 mm/s to 200 mm/s.

Sheet Separation—The glass sheet 34 with the surface masks 26, 28 shown in FIG. 2 can be separated into multiple glass articles using any suitable separation technique, such as a laser separation technique or mechanical separation technique. The individual glass articles will each have a portion of the masks 26, 28 on its surfaces. In one illustrative embodiment, separation paths 42, 44 are defined in the layer containing the printed masks 26, 28. The separation paths 42, 44 are defined by the pattern of the printed masks 26, 28 on the glass surfaces 30, 32. The patterning is such that there is no mask material in the separation paths 42, 44 and the glass sheet 34 is exposed at the separation paths 42, 44. In this illustrative embodiment, separation of the glass sheet 34 is carried out along the separation paths 42, 44 and only through the thickness of the glass sheet 34. In an alternative embodiment, one of the separation paths 42, 44 may be omitted, i.e., one of the masks 26, 28 may be patterned with a separation path while the other is not.

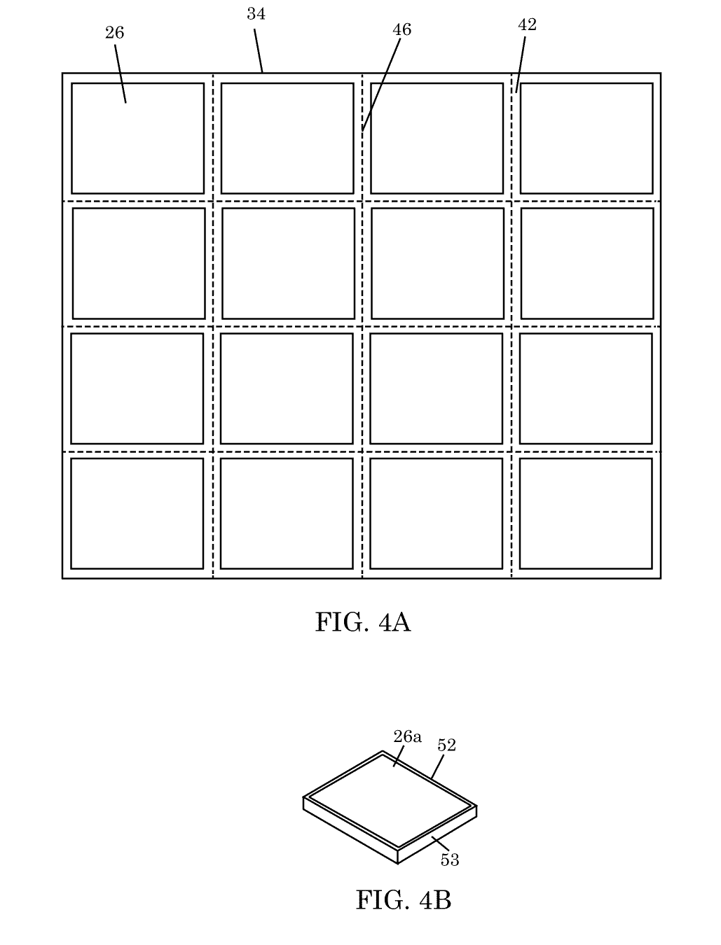

In one embodiment, a laser separation technique is used for separating the glass sheet 34. In this technique, a laser source is used to heat the glass sheet 34 along the separation paths 42 and/or 44 (see 44 in FIG. 2). A cooling fluid is then applied to the heated separation paths to create thermal shock in the glass sheet 34 along the separation paths, resulting in score lines along the separation paths. FIG. 4A shows score lines 46 for illustration purposes. It should be noted that the network of separation paths 42 shown in FIG. 4A can be varied as necessary to suit the shapes of glass articles to be separated from the glass sheet. The glass sheet will separate easily along the score lines 46 after the laser scoring. Alternatively, a mechanical separation technique may be used to separate the glass sheet 34. The mechanical separation technique may involve drawing a scoring wheel along the glass in the separation paths 42 or 44 to form score lines in the glass. The glass sheet can then be separated easily along the score lines.

The separation paths in the surface mask layers make separation of the glass sheet 34 easy and clean. If there are no defined separation paths in the surface mask layers as explained above, the glass sheet may break unevenly during its separation or may not break along score lines formed by the separation technique.

FIG. 4B shows an example of a glass article 52 separated from the glass sheet 34. It should be noted that the shape of the glass article 52 is rectangular for illustration purposes only. That is, the glass article 52 may have any desired shape for the intended use of the glass article. The glass article 52 has portions of the masks 26, 28 (only portion 26a of mask 26 is visible in FIG. 4B) on its surfaces.

Edge finishing—The edges (53 in FIG. 4B) of the glass articles separated from the glass sheet 34 are finished. Finishing involves removing cracks and chips formed in the glass edges and shaping the glass edges to a desired edge profile, usually from a flat edge profile to a non-flat edge profile, such as a chamfered (or beveled) profile or round (or bullnose) profile. Machining techniques such as grinding, lapping, and polishing may be used to finish the edges. In some embodiments, finishing involves grinding the glass edges using a grinding tool made of an abrasive material such as alumina, silicon carbide, diamond, cubic boron nitride, or pumice. Grinding is done in several passes, with each successive pass using an appropriate grit size. In general, grinding starts with a high grit size and ends with a small grit size. The higher the grit number, the less aggressive is the material removal. An example sequence of grit sizes is a 280 grit, followed by a 600 grit. Another example is 320 grit, followed by 600 grit. The glass edges are shaped into the desired profile during the grinding. After grinding, the edges are polished using a polishing tool, which may be in the form of a wheel, pad, or brush. Abrasive particles can be loaded onto the polishing tool, where polishing would then involve rubbing or brushing the abrasive particles against the edges of the glass articles. After polishing, the edges of the glass articles will be smooth. In one example, surface roughness of the edges is less than 100 nm, as measured by a ZYGO® Newview 3D optical surface profiler, after finishing.

Finishing or machining of the glass edges may be carried out on a computer numerical control machine. One example of a suitable CNC machine is CL-3MGC C-2Z CNC machine, available from Chuan Liang Industrial Co., Ltd. The glass articles may be finished one at a time. Alternatively, several or all of the glass articles may be finished simultaneously. This simultaneous finishing can be accomplished by stacking the glass articles in a suitable fixture that exposes the edges of the glass articles and securing the fixture in a working position on the machine. Finishing or machining tools, such as grinding tools and polishing tools, can then be applied to the glass articles to remove material from the edges of the glass articles as needed to achieve a desired roughness level and shape profile at the edges. U.S. patent application Ser. No. 13/803,994 describes a method of finishing several glass sheets simultaneously. The disclosure of this patent application is incorporated herein by reference in its entirety.

Edge etching—The finished edges of the glass articles will most likely have flaws at the micron to sub-micron level, which may have been induced by either or both of the sheet separation (12 in FIG. 1) and edge finishing (14 in FIG. 1). In one illustrative embodiment, acid etching is used to remove the flaws or substantially reduce the length and/or tip radius of the flaws. Etching involves immersing the finished or machined edges in an etching medium containing an inorganic acid that is capable of reacting with the glass material. The etching medium may be in aqueous or gel form. Typically, the inorganic acid will be hydrofluoric acid (HF). The etching medium may further include one or more mineral acids, such as hydrochloric acid (HCl), nitric acid (HNO₃), sulfuric acid (H₂SO₄), or phosphoric acid (H₂PO₄). The inorganic acid may be present in the aqueous medium in an amount of about 1% up to 50% by volume. The mineral acid may be present in the etching medium in an amount up to 50% by volume. In one example, the etching medium is composed of 5 wt % HF and 5 wt % HCl at room temperature.

The duration of the etching is dictated by the desired reduction in the number of flaws or the desired reduction in the length and/or tip radius of the flaws in the glass edges. In one illustrative example, the glass edges are immersed in a bath containing an etching medium, e.g., HF/HCl, for 32 minutes and then rinsed in water, with ultrasonic agitation, for 5 minutes. An entire glass article may be immersed in the etching medium. For this reason, the surface masks on the glass articles should not interact with the etching medium or the interaction rate should be very slow that an effective thickness of the surface masks remains on the glass articles after the etching. The glass articles may be processed in the etching medium one at a time. Alternatively, several glass articles may be processed in the etching medium simultaneously. For simultaneous processing, the glass articles can be supported in a suitable etching fixture configured to hold multiple glass articles in a bath containing an etching medium. An example of such a fixture is disclosed U.S. Provisional Application No. 61/731,955.

Edge coating—Usually, there will be flaws in the edges of the glass articles after the edge etching. To prevent direct impact with these flaws, and thereby improve the impact resistance of the glass articles, a curable coating is applied to the glass edges to cover up the flaws. In one embodiment, the curable coating is applied to the glass edges by a dip-and-spin coating process. In another embodiment, the curable coating is applied to the glass edges by a spray coating process. The curable coating may also be applied by a dip coating, i.e., without spin, process.

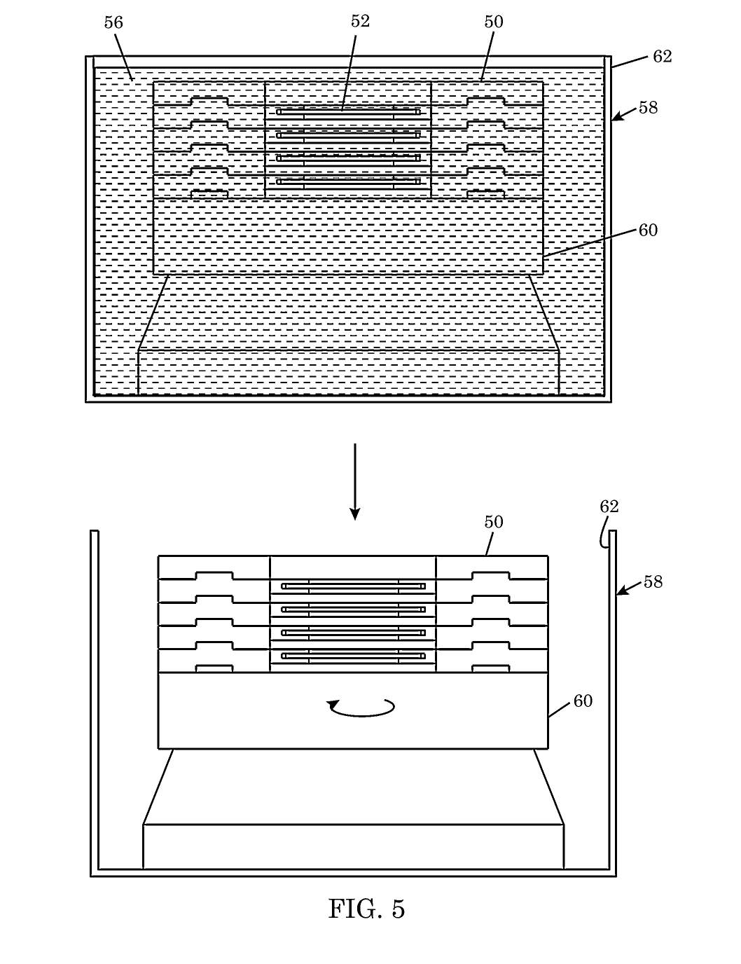

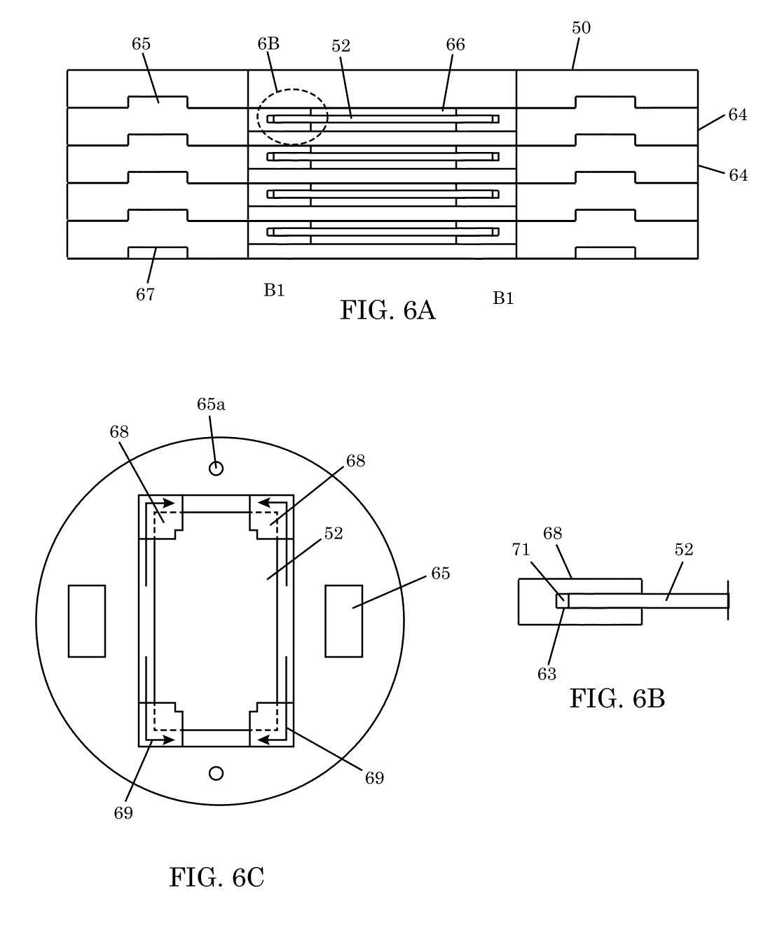

FIG. 5 is an illustrative embodiment of a dip-and-spin coating system for coating the edges of a batch of glass articles. The system includes a cassette 50 for holding a batch of glass articles 52, coating material 56 and a spin coater 58 including a spinner 60, which is placed within a tank 62. Spin coaters are available commercially, e.g., from Tien Shiang Trade & Engineering Co., Ltd. In FIG. 6A, the cassette 60 is made of several stackable plates 64. For example, the cassette 60 may have 5 to 20 plates. Alignment tabs 65 and slots 67 may be provided on the plates 64 to assist in stacking the plates. Alignment pins 65a (in FIG. 6C) may also be used to assist in stacking the plates. The stacked plates 64 may be further secured together using means such as bolts and the like. Each plate 64 includes a slot 66 in which a glass article 52 can be arranged. The slot 66 is open at the sides so that coating material may flow through the slot 66 and around the edge of the glass article 52 arranged in the slot 66. The corners of each glass article 52 are inserted in slots (63 in FIG. 6B) in the corner fixtures 68. As shown in FIG. 6B, the corner of the glass article 52 is held snugly in the slot 63 of the fixture 68, but there is also space 71 remaining in the slot 63 to allow for flow of coating material around the corner of the glass article 52, as indicated by arrows 69 in FIG. 6C. In the cassette 50 (in FIGS. 5 and 6A), each slot 66 of a plate 64 contains an assembly of glass article 52 and corner fixtures 68 (in FIGS. 6A and 6B). When the plates 64 are stacked and secured together, the fixtures 68 will be clamped in place. The fixtures 68 will prevent the glass articles 52 from moving around or falling out of the cassette 50 during the spinning portion of the dip-and-spin coating process. The plates 64 can be made of any suitable material, but may need to be coated with some fluoride. Examples of suitable plate materials are stainless steel and acrylic material.

Returning to FIG. 5, the edge coating can be carried out by assembling a batch of glass articles 52 in the cassette 50 and attaching the cassette 50 to the spinner 60 in the tank 62. At this point, the spinner 60 is stationary and there is not enough coating material in the tank 62 to submerge the cassette 50. The tank 62 is then filled with coating material 56 such that the cassette 50 and the glass articles 52 are submerged in the coating material. The coating material will enter the cassette slots (66 in FIG. 6A) in which the glass articles 52 are arranged and coat the edges of the glass articles 52 as well as the surface masks on the glass articles 52. Subsequently, the coating material 56 is emptied out of the tank 62. This completes the dipping portion of the coating process. In an alternative embodiment, the dipping could be achieved by putting the coating material in each of the slot of the cassette 50 containing a glass article 52. The glass article 52 will be submerged in the coating material in the slot. If necessary, in both dipping methods, the cassette 50 can be tilted in various directions to allow full coating of the edges of the glass articles 52.

After the dipping, the spinner 60 is operated to rotate at a select speed, which causes the cassette 50 to spin. During this spinning, excess coating material will be removed from the glass articles 52 by centrifugal force. The spinning speed and time can be controlled to achieve the desired thickness and quality of coating on the edges of the glass articles 52. In general, the higher the rotational speed, the thinner the coating thickness will be. Also, the longer the duration of the spinning, the thinner and smoother the coating thickness will be. After spinning, the cassette 50, with the glass articles 52, is transferred to an oven for pre-curing (20 in FIG. 1) of the coating material.

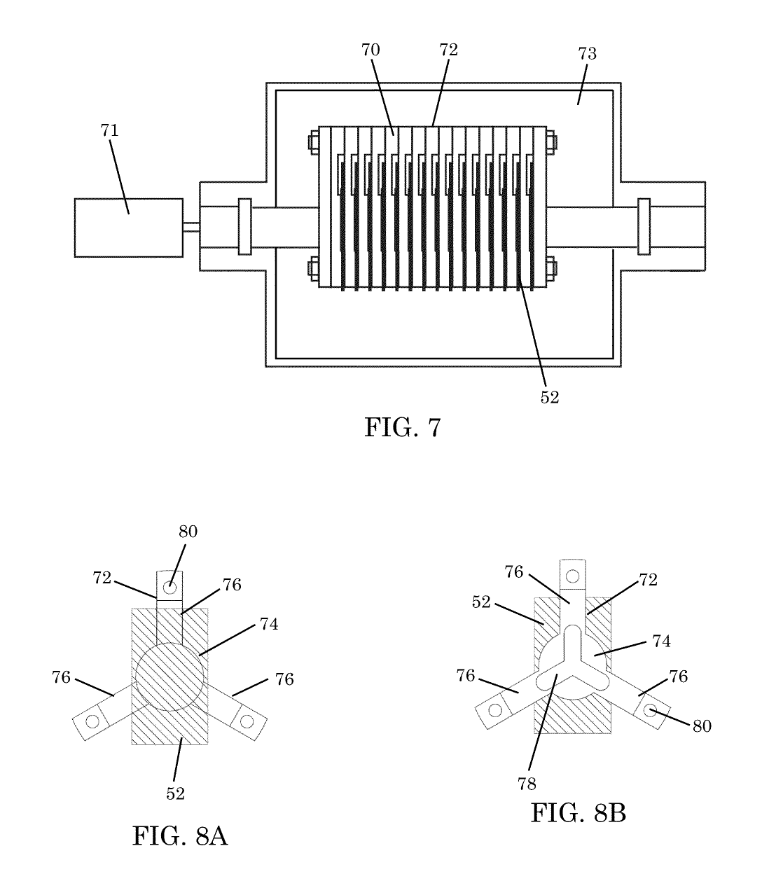

FIG. 7 shows a different dip-and-spin coating system that could be used for coating the edges of a batch of glass articles. The system includes a cassette 70 for holding a batch of glass articles 52. The cassette 70 is coupled to a rotary motor 71, which can be operated to rotate the cassette 70 for the spinning portion of the dip-and-spin coating process. The cassette 70 is disposed in a chamber 73, which can be filled with coating material for the dip portion of the dip-and-spin coating process. The cassette 70 is made of several stackable plates 72, one of which is shown in FIGS. 8A and 8B. In FIGS. 8A and 8B, the plate 72 has a central body 74 and radial arms 76 extending from the central body 74. In FIG. 8B, a spacer 78 is provided at the bottom side of the central body 74. The spacer 78 may also have radial design for balanced stacking of the plates. A glass article 52 is arranged on the top side of the plate 72, i.e., the side that does not include the spacer 78, as shown in FIG. 8B. When the plates 72 are arranged in a stack, the spacer 78 of one plate 72 will contact the glass article 52 supported on an adjacent plate 72. Also, the edges of the glass articles 52 will be exposed at the periphery of the cassette. The stacked plates 72 may be secured together using any suitable means, such as bolts inserted through holes 80 in the radial arms 76.

The system shown in FIG. 7 may also be used for a dip coating process. In this case, the cassette 70 will not be submerged in the coating material—the coating material need only be in an amount sufficient to touch the bottom edges of the glass articles in the cassette 70. The rotary motor 71 can be operated to rotate the cassette 70 to allow the entire edges of the glass articles 52 in the cassette 70 to be coated with the coating material.

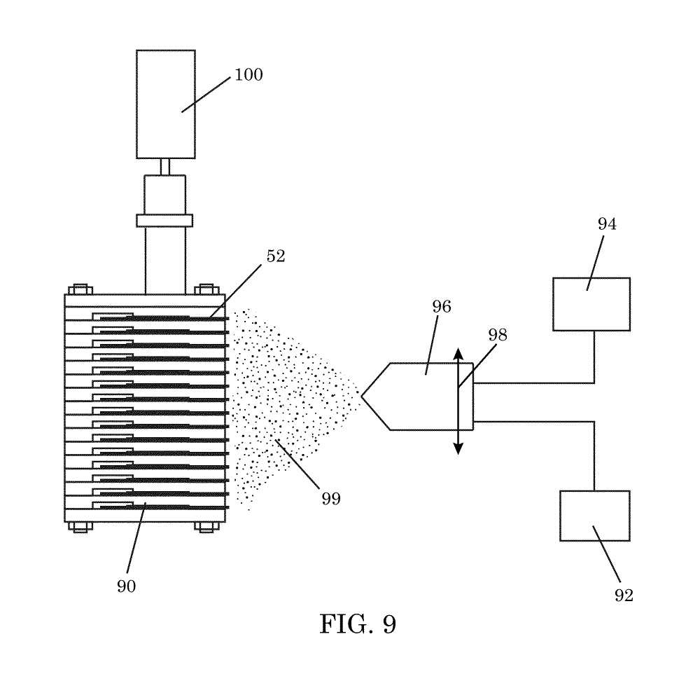

FIG. 9 shows a spray coating system for batch edge coating. The system includes a cassette 90 for holding a batch of glass articles. The cassette 90 is the same as the cassette 70 in FIG. 7, although other types of cassettes may be used, such as the one shown in FIG. 6A, or a vacuum chuck may be used. The system also includes a reservoir 92 containing a coating material, a source of carrier gas 94, and a mist generator (spray machine or nebulizer) 96. For the spray coating, the coating material is delivered to the mist generator, which atomizes the coating material to droplets. Carrier gas from the source 94 carries the droplets 99 to the edges of the glass articles 52 in the cassette 90. The distance between the spray end of the mist generator 96 and the cassette 90 may be selected such that the sprayed droplets will cover all the glass edges along the length of the cassette 90 without a need to adjust the position of the mist generator 96 relative to the cassette 90. Alternatively, the mist generator 96 may be translated back and forth along the length of the cassette 90, as shown by arrow 98, so that all the glass edges along the length of the cassette 90 are sprayed with the coating material. Also, while the coating material is being sprayed on the glass edges, the cassette 90 can be rotated, e.g., using a rotary motor 100 coupled to the cassette 90, to allow for a uniform coating on the glass edges along the circumference of the cassette.

In one illustrative embodiment, the curable coating material is a polymeric resin. Polymeric resin has high transparency, good wettability on glass surface, and is available in liquid form. In one illustrative embodiment, the curable coating material is selected from acrylic, epoxy, silicone, transparent polyimide, and hard coating material. The curable coating may be applied to the glass edges by dip-and-spin, spraying, or dip coating process. For mass glass edge coating, the glass articles are arranged in a cartridge appropriate for the coating process, and the coating material is applied simultaneously to all the glass edges. In the dip-and-spin process, the glass articles are dipped into the coating material. At least for this coating process, it is preferable that the coating material does not interact with the masks on the glass surfaces so as to allow the masks to protect the glass surfaces during the edge coating.

Preferably, the coating material is free of organic solvents, which can permeate polymers and cause polymers to swell. If the coating material comprises a solvent, then the solvent in the coating material may permeate the masks, causing the masks to swell and wrinkle. This will make the masks ineffective in protecting the glass surfaces during the edge coating. A UV curable coating material can be prepared without an organic solvent. If the coating material is not a UV curable coating material, e.g., is a thermally curable coating material, or still needs an organic solvent, the solubility parameters of the masks and coating material should be taken into consideration. It has been observed that when the solubility parameter of a polymer is equal to or not more than ±1.5 of the solubility parameter of a solvent, the polymer can be dissolved in this solvent. Otherwise, the polymer is insoluble. Therefore, any solvent used in the coating material should be selected such that the masks will be insoluble in the solvent.

Pre-curing—After applying the coating material to the glass articles, the glass articles are transferred into an oven for pre-curing of the coating material. For silicone coating material, for example, the pre-curing can take place at 150° C. for 1 minute. UV light is used for curing if the coating material is a UV curable coating material.

Surface Unmasking—After the pre-curing, the surface masks are removed from the glass articles. The surface masks can be removed manually in whole since cohesion of the masks is high.

Post-curing—After removing the surface masks, the glass articles are transferred to the oven again for curing of the coating material. The curing can take place at the same temperature as the pre-curing but for a longer duration, e.g., 9 minutes. Again, UV light is used for curing if the coating material is a UV curable coating material.

### EXAMPLE 1

An automatic screen printer Model No. CG1CF0510 from Built-In

Precision Machine Co. Ltd, Taiwan, was used to print a mask on a surface of a glass substrate. The screen printer and screen properties are as shown in Table 2. The ink (mask material) used for screen printing had a viscosity of 400 Pa·s, and the printing speed was 80 mm/s. The squeegee hardness was 70H, and the printing angle, i.e., angle of the squeegee blade relative to the screen, was 18°. The curing condition of the ink was 150° C. for 1 hour. The thickness of the printed mask was about 80 μm.

TABLE 2

| Screen Printer | | | Screen | |
|---|---|---|---|---|
| Substrate Size | 60-100 | mm | Material | PET |
| Substrate thickness | 0.25-1.5 | mm | Mesh | 200 Mesh |
| Gap | 0-5 | mm | Open ratio | 26.5 |
| Pressure | 0-10 | bar | Mesh count tension | 23 |
| Flood bar speed | 10-400 | mm/s | Thread angle | 22.5 |
| Squeegee speed | 10-400 | mm/s | Emulsion thickness | 100 μm |

### EXAMPLE 2

The glass substrate of Example 1 was separated into multiple glass articles. Each glass article was finished by machining. Each of the finished glass articles had a C-chamfer edge profile.

### EXAMPLE 3

The glass articles of Example 2 were immersed in an etching medium for etching of the glass edges. The etching medium was an aqueous solution comprising 5% by weight HF and 5% by weight of HCl. The glass articles were immersed in the a bath containing the etching medium for 32 minutes and then rinsed in water, with ultrasonic agitation, for 5 minutes.

### EXAMPLE 4

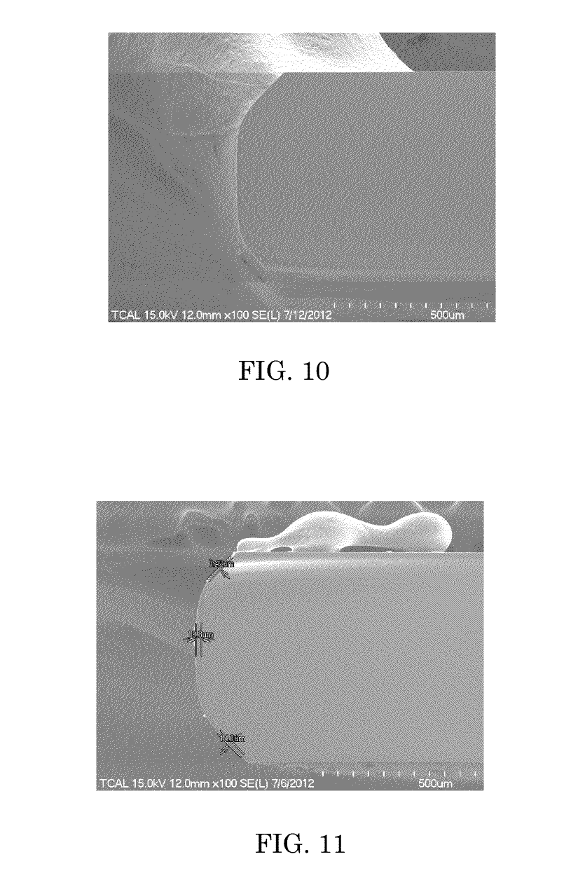

Several of the glass articles of Example 3 were loaded into a cassette. A curable coating was then applied to the edges of the glass articles in the cassette using a dip-and-spin coating process. Silicone with a viscosity of 80 cps was used as the curable coating material. The spin speed was 300 rpm, and the spin time was 10 seconds. After spinning, the cassette was transferred to an oven to pre-cure at 150° C. for 1 minute. Afterwards, the glass articles were unloaded from the oven and the surface masks were removed from the glass articles. The glass articles were then cured again at 150° C. for 9 minutes. The thickness of the edge coating was around 16 μm. FIG. 10 is a SEM image of the edge coating by dip-and-spin. There was no observed overflow on the glass surfaces with the dip-and-spin coating process.

### EXAMPLE 5

Example 4 was repeated for other glass articles, but with spraying as the method of applying the curable coating to the edges of the glass articles. The thickness of the edge coating was around 18 μm. FIG. 11 is a SEM image of the edge coating by spraying. Some bubbles were observed in the edge coating obtained by spraying. It may be possible to remove the bubbles using a post-treatment process. However, for Example 5, the bubbles were not removed.

Table 3 shows vertical ball drop test results for a glass sample that was not edge coated (non-coated glass sample), a glass sample that was prepared as described above with dip-and-spin as the method of edge coating (dip-and-spin coated glass sample), and a glass sample that was prepared as described above with spraying as the method of edge coating (spray coated glass sample). The glass samples each had an edge thickness or height of 1.1 m. The mass of the ball drop was 0.5 kg.

Table 3 shows that the non-coated glass sample did not break up to a drop height of 6 cm (corresponding to 43.6 MPa impact). The dip-and-spin-coated glass sample did not break up to a drop height of 16 cm (corresponding to 67.88 MPa impact). The spray-coated glass sample did not break up to a drop height of 12 cm (corresponding to 60 MPa). The improvement in impact resistance of the dip-and-spin-coated glass sample over the non-coated glass sample is 56%. The improvement in impact resistance of the spray-coated glass sample over the non-coated glass sample is 38%. There were bubbles in the spray-coated glass edge, which may account for the lower improvement in impact resistance compared to the dip-and-spin coated glass edge.

TABLE 3

| Ball Drop | Non-coated | Dip-And-Spin | Spray |
|---|---|---|---|
| Height (cm) | glass | coated glass | coated glass |
| 6 | ∘ | ∘ | ∘ |
| 7 | x | ∘ | ∘ |
| 8 | x | ∘ | ∘ |
| 9 | | ∘ | ∘ |
| 10 | | ∘ | ∘ |
| 11 | | ∘ | ∘ |
| 12 | | ∘ | ∘ |
| 13 | | ∘ | x |
| 14 | | ∘ | |
| 15 | | ∘ | |
| 16 | | ∘ | |
| 17 | | x | |
| 18 | | x | |
| 19 | | x | |

Table 4 compares batch coating of glass edges (BC) as described above to piece-by-piece coating of glass edges (PC). In piece-by-piece coating, jetting, roller, and dispensing were used to apply a coating material to the glass edges. The analysis is divided into three parts: thickness and uniformity, overflow, mechanical tolerance. From Table 4, batch coating scores higher than piece-by-piece coating in terms of glass edge coating performance. Also, while both dip-and-spin and spraying are capable of being used for edge coating, dip-and-spin edge coating generally scores higher than spray edge coating in terms of glass edge coating performance.

TABLE 4

| Product | | BC | | | Scoring Scale | | |
|---|---|---|---|---|---|---|---|
| Performance | Weight | D + S | S | PC | 5 | 3 | 1 |
| Visual inspection - | 10% | 5 | 3 | 1 | smooth | some | very |
| edge waviness | | | | | | | |
| Coating thickness - | 20% | 5 | 5 | 5 | <30 μm | 30-100 μm | >100 μm |
| average | | | | | | | |
| Coating thickness - | 10% | 5 | 5 | 3 | 30 μm | 50 μm | 100 μm |
| uniformity | | | | | | | |
| Overflow - | 5% | 5 | 5 | 1 | <10 μm | >10 μm | >20 μm |
| thickness (y) | | | | | | | |
| Overflow - extent | 5% | 5 | 5 | 1 | <50 μm | >50 μm | >100 μm |
| beyond edge (x) | | | | | | | |
| Visual inspection - | 10% | 5 | 5 | 3 | none | some | a lot |
| material on surface | | | | | | | |
| Visual inspection - | 20% | 5 | 5 | 3 | whole | >90% | <90% |
| coverage | | | | | | | |
| Mechanical test - | 30% | 5 | 3 | 1 | >50% | >30% | >10% |
| edge ball drop | | | | | increase | increase | increase |
| | Total | 5 | 4.4 | 2.6 | | | |

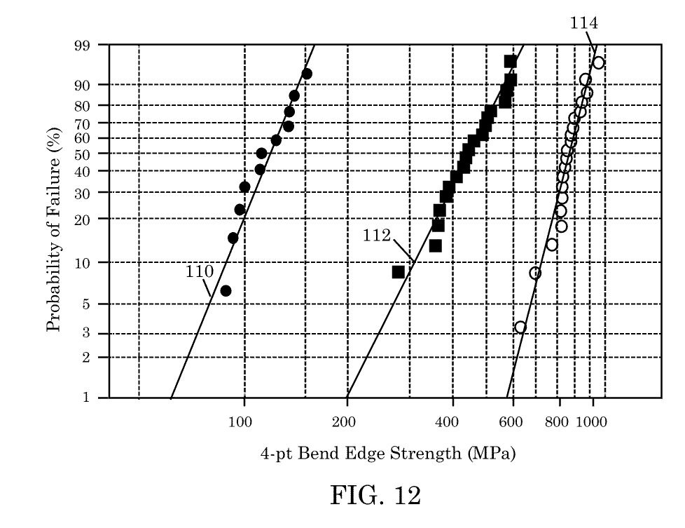

FIG. 12 compares the edge strength of glass articles without coated edges with glass articles having coated edges. Line 110 represents the edge strength of glass articles without coated edges. Line 112 represents the edge strength of glass articles with coated edges after damage. Line 114 represents the edge strength of glass articles with coated edges before damage. The coating was applied to the coated edges by dip coating. The glass articles with coated edges showed improvements of 80 MPa to 300 MPa in edge strength over the glass articles without coated edges.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

1. A method of edge coating a batch of glass articles, comprising:
printing masks on surfaces of a glass sheet, at least one of the masks being a patterned mask defining a network of separation paths;
dividing the glass sheet with the printed masks into multiple glass articles along the separation paths, each of the glass articles carrying a portion of the printed masks on surfaces thereof;
for at least a batch of the glass articles, finishing edges of the glass articles in the batch to reduce roughness at the edges;
etching each finished edge with an etching medium comprising at least one inorganic acid to reduce at least one of a length and tip radius of at least one flaw in the finished edge;
simultaneously applying a curable coating to the etched edges;
pre-curing the curable coatings applied to the etched edges;
removing the masks from the glass articles with the curable coatings; and
post-curing the pre-cured curable coatings after removing the masks.

2. The method of claim 1, wherein printing of the masks is by screen printing.

3. The method of claim 2, wherein the masks are resistant to the at least one inorganic acid.

4. The method of claim 2, wherein the masks are printed from an ink comprising 10% to 60% by weight of an oligomer and 10% to 40% by weight of a monomer.

5. The method of claim 4, wherein the ink used in printing the masks further comprises 1% to 15% by weight of a photoinitiator.

6. The method of claim 4, wherein the ink used in printing the masks further comprises at least one additive selected from fillers, silane coupling agents, and light blocking agents in a total amount up to 30% by volume.

7. The method of claim 1, wherein a thickness of each mask is in a range from 30 μm to 50 μm.

8. The method of claim 1, wherein the curable coating is a polymer resin.

9. The method of claim 1, wherein the curable coating is free of an organic solvent.

10. The method of claim 1, wherein finishing the edges further comprises shaping the edges into a non-flat profile.

11. The method of claim 1, wherein the at least one inorganic acid is hydrofluoric acid.

12. The method of claim 11, wherein the etching medium further comprises at least one mineral acid.

13. The method of claim 1, wherein simultaneously applying the curable coating comprises loading the batch of glass articles into a cassette configured to hold the batch of glass articles and applying the curable coating to the etched edges of the glass articles while the glass articles are in the cassette.

14. The method of claim 1, wherein the curable coating is applied by a dip-and-spin process.

15. The method of claim 1, wherein the curable coating is applied by a dip process.

16. The method of claim 1, wherein the curable coating is applied by a spraying process.
